(19) United States
(12) Patent Application Publication
(10) Pub. No.: US 2010/0117270 A1
(43) Pub. Date: May 13, 2010

(54) Extrusion molding technique and synthetic stopper produced therefrom

(76) Inventor: Jan Alac, Ontario (CA)

Correspondence Address: HARRINGTON & SMITH, 4 RESEARCH DRIVE, Suite 202, SHELTON, CT, 06484-6212, US

(21) Appl. No.: 12/291,461

(22) Filed: Nov. 10, 2008

(51) Int. Cl. B29C 43/02; B28B 11/16

(52) U.S. Cl. 264/544; 425/342.1

(57) ABSTRACT

Exemplary embodiments of the invention provide an extrusion molding method and system that may be utilized to produce one or more objects having a desired shape, such as a shape suitable for a synthetic wine cork, for example. In one exemplary embodiment, a method includes: extruding a material including a blowing agent through a die; cutting the extruded material to obtain at least one piece; placing the at least one piece in a mold; and allowing the at least one piece to expand and cool within the mold in order to form a produced object, where the produced object has a predefined shape based on the mold.

### TECHNICAL FIELD

The exemplary and non-limiting embodiments of this invention relate generally to molding processes and techniques and, more specifically, relate to extrusion molding and products created therefrom, such as synthetic stoppers, for example.

### BACKGROUND

### I. Molding

Molding is a manufacturing process that uses a rigid frame or model, often called a mold, to shape pliable raw material. The entity that is used to shape the material may generally be referred to as a mold or mould. For example, a mold may comprise a hollowed-out block that is filled with raw material. As a non-limiting example, the raw material may comprise a liquid, such as plastic, glass, metal, or ceramic. Inside the mold, the liquid hardens or sets, adopting a shape based on the mold. There are a number of different molding techniques and processes including the exemplary ones described below.

In extrusion molding, a raw material is pushed and/or drawn through a die having a desired cross-sectional shape/profile. This process may also be referred to simply as extrusion or extruding. Extrusion molding is often used to produce long lengths (e.g., in a continuous fashion), or a plurality of shorter lengths (e.g., in a semi-continuous fashion) having a substantially consistent cross-section. Use of a pin can enable the formation of one or more interior hollow sections.

With extrusion molding, the raw material may be forced through the die using one of a variety of different methods. For example, a screw auger (e.g., powered by a motor) or a ram (e.g., powered by hydraulic oil pressure) may be utilized.

Foam extrusion utilizes a process similar to the above-mentioned extrusion molding, whereby a material (e.g., a mixture of plastic and foaming agents) is forced through a die. However, in foam extrusion the foamed profile expands upon exiting the die due to the foaming agents.

For injection molding, the material (e.g., molten plastic) is injected at high pressure into a mold that is the inverse of the product's shape. This is generally a start-and-stop operation. That is, the injection of the material must be halted, for example, while the injected material is cooled and ejected from the mold (e.g., to reuse the mold) and/or while the injection molding apparatus switches between molds.

In compression molding, the material, usually preheated, is first placed in an open, heated mold cavity. The mold is closed and pressure is applied (e.g., via the force of closing the mold or by pushing on a plug) to force the material into contact with the mold areas, and heat and pressure are maintained until the material has set.

In transfer molding, after preheating, the material (e.g., a thermoset resin) is loaded into a chamber known as a pot. The material is then forced (e.g., injected using a plunger) from the pot, via channels, into the mold cavities. The channels are referred to as a sprue and runner system. As the material is inserted, the mold remains closed. Once the material has set, the mold is opened and the product removed from the mold. Thus, unlike compression molding, transfer molding uses a closed mold.

Rotational molding is a high temperature, low pressure process. Heat and biaxial rotation (rotation on two axes) are used to produce individual hollow pieces. Raw material (e.g., a polymer in powder form) is loaded in the mold. The mold, while being rotated, is heated in an oven until the raw material has melted and adhered to the walls of the mold. The mold is then cooled and the product removed from the mold.

Thermoforming shapes thermoplastic films or sheets into a desired shape. A film or sheet is first heated to its forming temperature. The heated film/sheet is then stretched over a single-surface mold (e.g., a positive mold or a negative mold). Until it cools, the film/sheet is held against the surface of the mold. The molded product is trimmed from the cooled film/sheet.

Blow molding is used to form hollow plastic parts or containers (e.g., plastic bottles). There are three main types of blow molding, as described further below: extrusion blow molding, injection blow molding, and stretch blow molding.

With extrusion blow molding, the material (e.g., plastic) is melted and extruded to form a hollow tube, called a parison. The parison is enclosed within the mold and air is blown into the parison. As this occurs, the parison is inflated and takes on the shape of the mold. Extrusion blow molding is commonly used to form hollow plastic bottles or containers.

In injection blow molding, the material is first injection molded onto a core pin or rod. The material, while attached to the core rod, is subsequently inflated using a blow molding station. That is, the material is first injected into a hollow preform mold that is attached to the core rod. For example, the preform mold may comprise a bottle/jar neck attached to the material that will form the body of the bottle/jar. At the blow molding station, the core rod opens, allowing compressed air to be blown into the preform. This inflates the material to the desired shape, as based on the surrounding mold. After setting, once the core rod is removed and the part ejected, one is left with an article of the desired shape.

In some aspects, stretch blow molding is similar to injection blow molding. First, the material is molded into a preform using injection molding (as described above). For example, the preform may comprise a bottle/jar neck attached to the material that will form the body of the bottle/jar. After cooling, the preform is subsequently inflated using a blow molding station. However, in stretch blow molding, the preform is reheated (e.g., above its glass transition temperature) and blown again using high pressure air.

### II. Cork Stoppers

Natural cork is a material that is often used as a stopper for enclosures, such as jars or wine bottles. More specifically, due to its characteristics, natural cork is generally preferred for wine bottle stoppers. Natural cork is compressible, though sufficiently elastic to retain its shape. Natural cork can provide a leak-tight seal and is hydrophobic.

Notwithstanding the benefits, there are a number of disadvantages to using natural cork as a bottle stopper, including: natural cork can dry and crumble with age, sometimes leading to problems in fully extracting the cork from the bottle without the cork falling into the contents of the bottle; there is a potential for contamination from trichloroanisole (TCA); and the structure of natural cork can be inconsistent, potentially leading to leakage and/or spoiling or ruining of the bottle's contents.

One alternative to a natural cork is to use a synthetic cork comprised of a plastic, for example. Described below are three examples of conventional synthetic wine corks.

(i) One type of synthetic wine cork is formed by continuous co-extrusion, where an exterior covering (a jacket) of the cork is extruded from solid plastic and simultaneously filled with a plastic foam (an interior material). The synthetic cork is continuously extruded in long rods that are cut to shorter lengths (e.g., for wine bottle stoppers) after cooling. The resulting wine bottle stopper has a relatively thicker skin. In addition, the ends of the synthetic cork (i.e., where the rod is cut) have the interior foam material exposed. As an example, such synthetic corks are produced by a company called Nomacorc©.

(ii) Another type of synthetic cork is produced by injection molding. This results in a synthetic cork having a relatively thin skin formed over the entire synthetic cork, with the skin produced from the same material as the core (due to the injection molding). However, synthetic corks produced in this manner also included flow marks on the finished product. As an example, the production of synthetic corks in this manner is described by Paisley et al. in U.S. Pat. No. 4,363,849, “Foamed Thermoplastic Resin Cork Having A Natural Cork-Like Appearance And A Method Of Injection Molding The Cork.”

(iii) A third type of synthetic cork is also produced by injection molding and similarly yields a relatively thin-skinned product. Unlike the synthetic cork described above in the second type, the third type is produced without the flow marks.

Further reference with regard to synthetic corks may be made to: U.S. Pat. No. 4,091,136 to O'Brien et al., U.S. Pat. No. 4,507,405 to Paisley et al., U.S. Pat. No. 6,695,997 to Yaniger, U.S. Pat. No. 6,793,972 to Falla et al., U.S. Pat. No. 6,911,171 to Lauer, U.S. Pat. No. 7,314,661 to Hueto, U.S. Patent Publication No. 2007/0202327 by Baban et al., and U.S. Patent Publication No. 2007/0203266 by Holmes et al.

### SUMMARY

In one exemplary embodiment of the invention, a method comprising: extruding a material comprising a blowing agent through a die; cutting the extruded material to obtain at least one piece; placing the at least one piece in a mold; and allowing the at least one piece to expand and cool within the mold in order to form a produced object, where the produced object has a predefined shape based on the mold.

In another exemplary embodiment of the invention, a system comprising: an extruder configured to extrude a material comprising a blowing agent through a die, the extruded material comprising an extruder output; and at least one mold configured to receive at least a portion of the extruder output, where the at least one mold defines an interior cavity of said at least one mold, said interior cavity having a specified shape, where the at least a portion of the extruder output is received in said interior cavity, where the at least a portion of the extruder output is configured to achieve the specified shape of the interior cavity by expanding and cooling within the interior cavity of the at least one mold in order to form a produced object.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 depicts an exemplary extrusion manufacturing system for producing plastic foam objects;

FIG. 2 illustrates one exemplary embodiment of the invention that may be used to produce synthetic stoppers (e.g., synthetic wine corks), as a non-limiting example;

FIG. 3 illustrates an exemplary continual manufacturing system suitable for use in conjunction with exemplary embodiments of the invention; and

FIG. 4 depicts another exemplary continual manufacturing system suitable for use in conjunction with exemplary embodiments of the invention; and

FIG. 5 depicts a flowchart illustrating one non-limiting example of a method for practicing the exemplary embodiments of this invention.

### DETAILED DESCRIPTION

A few terms are defined below.

Pressure is considered to be the exertion of force upon a surface. As non-limiting examples, pressure may be exerted on the surface by an object, a fluid or a gas. As a further non-limiting example, pressure may be exerted from within a solid object (e.g., a non-hollow part) by the expansion of dissolved gases (e.g., a blowing agent or one or more foaming agents such as those used in foam extrusion, for example).

A parison is considered to be a hollow tube of material (e.g., plastic) to be formed into a hollow object (e.g., a hollow plastic object), such as a plastic bottle, by blow molding.

Extrusion (or extruding) is the formation of a product with a desired cross section by forcing a material through a die capable of producing the desired cross section. The material may comprise metal or plastic, as non-limiting examples. As previously noted, extrusion molding is often used to produce long lengths (e.g., in a continuous fashion), or a plurality of shorter lengths (e.g., in a semi-continuous fashion) having a substantially consistent cross-section.

It is briefly noted that a die is generally considered to comprise an opening, for example, that may be used with an extruder (e.g., for extrusion) to produce a desired cross section, as noted above. In contrast, a mold is generally considered to comprise an enclosure or enclosed space, for example, within which a material may achieve a desired shape. One non-limiting example of such a mold is a split mold. As one, non-limiting example, a split mold may comprise two or more parts that, when joined together along a seam, define an enclosed space for the production of objects having a desired shape (e.g., the enclosed space may be an inverse of the desired exterior shape of the produced objects). The two or more parts may be joined by tie bars, for example.

Plastic is the general term for a wide range of synthetic or semi-synthetic polymerization products. Plastics are generally composed of organic condensation or addition polymers and may comprise additional substances, often used to improve performance or reduce costs. There are many natural polymers generally considered to be plastics. The following are non-limiting examples of various plastics: polyethylene, polypropylene, polystyrene, poly(vinyl chloride), polyamide(nylon), polyester, polyurethane, etc. Note that plastics may be formed and/or manipulated by a variety of processes and techniques, including the molding techniques described above. Further note that, based on the various aspects and qualities of the materials and processes, not all plastics may be suitable for processing by every technique.

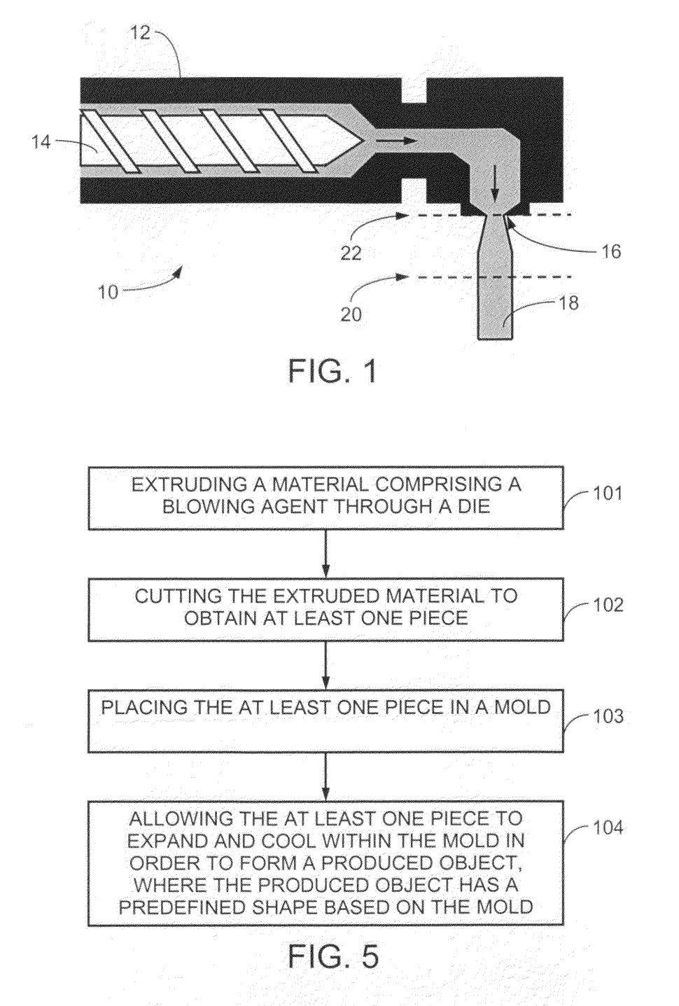

FIG. 1 depicts an exemplary extrusion manufacturing system 10 for producing plastic foam objects. Solid pellets, special additives and a blowing agent are fed into an extruder 12. The blowing agent may comprise a chemical blowing agent, a liquid gas or a mixture of the two, as non-limiting examples. Within the extruder 12, the materials are combined and melted, under controlled conditions of high pressure and temperature, into a viscous plastic melt. The hot plastic melt is forced through a die 16 by a screw auger 14 in a process that produces a continuous output 18 of melted compound with dissolved gas, for example.

As it emerges from the die 16 (as the output 18), the material expands to a foam which may be cooled, shaped and trimmed. The shape of the die 16 affects the cross sectional shape of the output 18. As a non-limiting example, the die 16 may have a substantially circular shape with the output 18 then having a generally cylindrical shape. The foam objects in question (i.e., the resulting objects) are produced by cutting the output 18. As non-limiting examples, the output 18 may be cut at regular intervals 20 (i.e., not at the die) or may be cut at the die 22 to produce one or more foam objects. The extrusion process results in a foam product having a substantially uniform closed-cell structure. Furthermore, the resulting product may have a substantially smooth continuous skin, for example, if the output is cut at the die.

Exemplary embodiments of the invention provide an extrusion molding method and system that may be utilized to produce one or more objects having a desired shape, such as a shape suitable for a synthetic wine cork, for example. In addition, further exemplary embodiments of the invention enable use of a continual manufacturing process that is able to produce a plurality of such objects in a substantially continuous fashion.

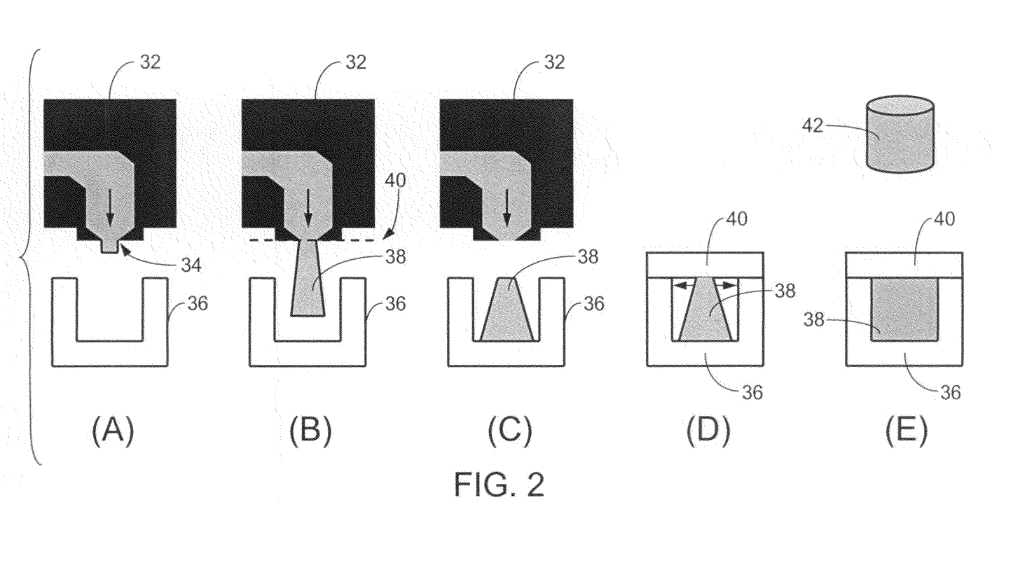

FIG. 2 illustrates one exemplary embodiment of the invention that may be used to produce objects, such as synthetic stoppers (e.g., synthetic wine corks), as a non-limiting example. In FIG. 2A, an extruder 32 forces hot, melted plastic through a die 34. A mold 36 is placed below the die 34 to catch the output. The interior shape of the mold 36 corresponds to the desired final shape of the produced object. In FIG. 2B, once an appropriate amount of material (the output 38) has been pushed through the die 34, the output 38 is cut 40 at the die 34. As shown in FIG. 2C, the output 38 then falls or is placed in the mold 36. In FIG. 2D, a lid or cap is placed on the mold 36 in order to enclose the output 38 within the mold 36. As another non-limiting example, if the mold 36 were to comprise a split mold, instead of placing a lid or cap the mold may be closed instead (e.g., assembled from two or more pieces). FIGS. 2D and 2E illustrate how, as the output 38 expands, the output 38 cools within the mold 36 and achieves the final desired shape. Once the output 38 has finished expanding and cooled within the mold 36, the mold 36 is opened and the output 28 is ejected such that the mold 36 can be reused.

In one non-limiting example, the final desired shape, as defined by the interior cavity of the mold 36, may comprise a generally cylindrical shape. In such a manner, the output 38 may be allowed to cool within the mold 36 and achieve the generally cylindrical shape. Once cooled and ejected from the mold 36, the output 38 may have a cylindrical appearance similar to the final output 42 shown in FIG. 2E.

As a non-limiting example, the final shape may comprise a shape suitable for the produced output to act as a stopper (e.g., a substantially cylindrical shape of suitable size). As a further non-limiting example, such a stopper may comprise a synthetic wine cork, such as one that may be used to stopper a wine bottle, for example. As another non-limiting example, the produced output may comprise a stopper suitable for use with different containers or enclosures, such other types of bottles, for example.

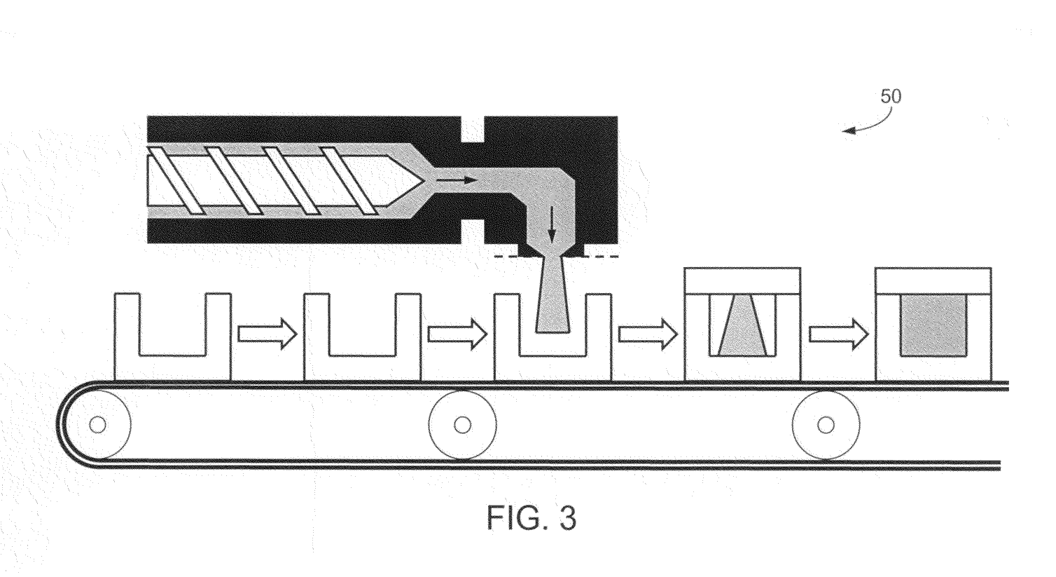

One non-limiting, exemplary benefit of the above-described exemplary embodiment(s) is that the process is continuous. Material can continually be extruded through the die 34 and cut 40 at suitable intervals based on the size of the desired product. A plurality of molds can be used such that while a first output is cooling within a first mold, a second output can be extruded, cut, placed in a second mold and allowed to expand and cool within said second mold. In such a manner, due to the continuous nature of the extrusion and by using a plurality of molds, the manufacturing process itself may be substantially continuous. FIG. 3 illustrates an exemplary continual manufacturing system 50 wherein a plurality of molds is used to achieve a substantially continual manufacturing (e.g., extrusion) process that produces a plurality of produced objects, each having one or more desired shapes, such as a plurality of synthetic wine corks, for example. In FIG. 3, a conveyor belt transports the plurality of molds in a substantially continual fashion, with the cavities passing beneath an output of the extruder.

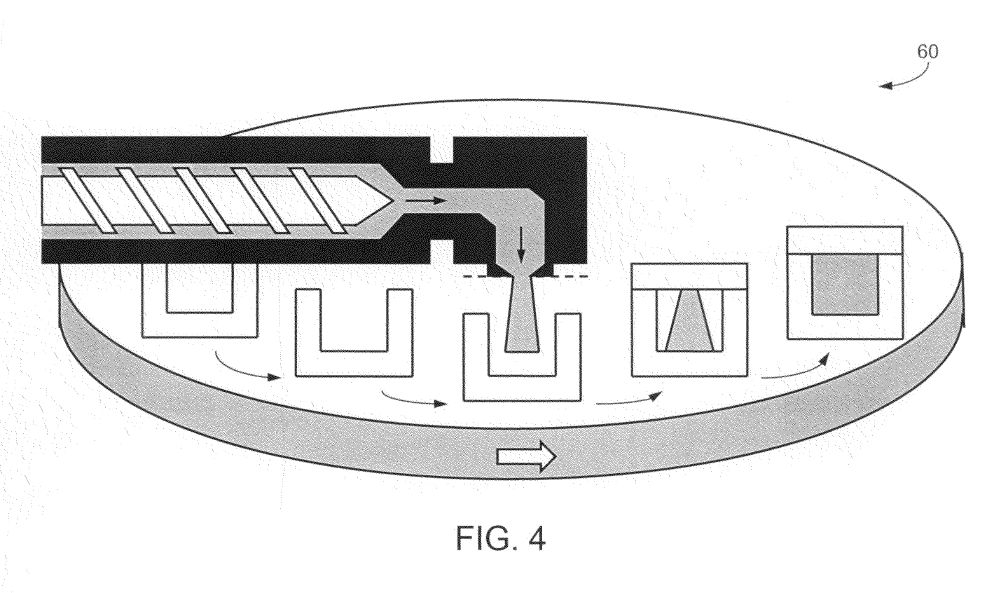

In other exemplary embodiments, instead of the exemplary conveyor belt arrangement illustrated in FIG. 3, a different arrangement or approach may be used. FIG. 4 depicts another exemplary continual manufacturing system 60 wherein a round table, or a substantially round/circular table, is rotated about, or substantially about, its central axis with a plurality of molds situated (e.g., spaced apart from one another, spaced from the edge of the round table) such that the molds pass under an output of the extruder in turn.

Such an exemplary carousel arrangement is but one non-limiting example of an alternative arrangement. One of ordinary skill in the art will appreciate that a number of different arrangements or approaches may be utilized in conjunction with the exemplary embodiments of the invention to provide a substantially continuous extrusion system and/or process.

As noted above, injection molding is generally a start-and-stop operation since the injection of the material into the mold must be halted, for example, while the injected material is cooled and ejected from the mold and/or while the injection molding apparatus switches between molds. In contrast, the above-described exemplary embodiments of the invention utilize continuous extrusion to produce the final objects. At least in some exemplary embodiments, while the continual process is in use there is no need to stop or otherwise interrupt the output of the extruder.

Furthermore, another non-limiting, exemplary benefit of the above-described exemplary embodiment(s) is that a skin is formed on all sides of the produced object. At least in some exemplary embodiments, this formation of skin on all sides of the produced object may be considered to be similar to the skin, formed on all sides of the produced object, for objects produced by injection molding (e.g., synthetic corks or stoppers).

Below are further descriptions of various non-limiting, exemplary embodiments of the invention. The below-described exemplary embodiments are numbered separately for clarity purposes. This numbering should not be construed as entirely separating the various exemplary embodiments since aspects of one or more exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.

(1) In one exemplary embodiment, and as illustrated in FIG. 5, a method comprising: extruding a material comprising a blowing agent through a die (101); cutting the extruded material to obtain at least one piece (102); placing the at least one piece in a mold (103); and allowing the at least one piece to expand and cool within the mold in order to form a produced object, where the produced object has a predefined shape based on the mold (104).

A method as above, where the at least one piece achieves the predefined shape due to pressure exerted by expansion of the blowing agent. A method as in any above, where the at least one piece achieves the predefined shape only due to the pressure exerted by expansion of the blowing agent. A method as in any above, where extruding the material through the die comprises a substantially continuous process such that the steps of cutting, placing and allowing are repeated for at least one subsequent piece in at least one additional mold.

A method as in any above, where the material comprises plastic, rubber or thermoplastic rubber. A method as in any above, where the material comprises a polymer, a copolymer, polyethylene, polystyrene or polypropylene, as non-limiting examples. A method as in any above, where the predefined shape comprises a shape suitable for the produced object to act as a stopper for an enclosure. A method as in any above, where the predefined shape comprises a shape suitable for the produced object to act as a synthetic wine bottle cork. A method as in any above, wherein the produced object comprises a stopper for an enclosure. A method as in any above, wherein the produced object comprises a synthetic wine bottle cork.

(2) In another exemplary embodiment, a system comprising: an extruder configured to extrude a material comprising a blowing agent through a die, the extruded material comprising an extruder output; and at least one mold configured to receive at least a portion of the extruder output, where the at least one mold defines an interior cavity of said at least one mold, said interior cavity having a specified shape, where the at least a portion of the extruder output is received in said interior cavity, where the at least a portion of the extruder output is configured to achieve the specified shape of the interior cavity by expanding and cooling within the interior cavity of the at least one mold in order to form a produced object.

A system as above, where the at least a portion of the extruder output achieves the specified shape due to pressure exerted by expansion of the blowing agent. A system as in any above, where the at least a portion of the extruder output achieves the specified shape only due to the pressure exerted by expansion of the blowing agent. A system as in any above, where the at least one mold comprises a plurality of molds, where the at least a portion of the extruder output comprises a plurality of portions, where extrusion of the material through the die by the extruder comprises a substantially continuous process such that the plurality of portions are received in a plurality of interior cavities of the plurality of molds.

A system as in any above, where the material comprises plastic, rubber or thermoplastic rubber. A system as in any above, where the material comprises a polymer, a copolymer, polyethylene, polystyrene or polypropylene. A system as in any above, where the specified shape comprises a shape suitable for the produced object to act as a stopper for an enclosure. A system as in any above, where the specified shape comprises a shape suitable for the produced object to act as a synthetic wine bottle cork. A system as in any above, wherein the produced object comprises a stopper for an enclosure. A system as in any above, wherein the produced object comprises a synthetic wine bottle cork.

Any use of the terms “connected,” “coupled” or variants thereof should be interpreted to indicate any such connection or coupling, direct or indirect, between the identified elements. As a non-limiting example, one or more intermediate elements may be present between the “coupled” elements. The connection or coupling between the identified elements may be, as non-limiting examples, physical, logical or any suitable combination thereof in accordance with the described exemplary embodiments.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications will still fall within the scope of the teachings of the exemplary embodiments of the invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
extruding a material comprising a blowing agent through a die;
cutting the extruded material to obtain at least one piece;
placing the at least one piece in a mold; and
allowing the at least one piece to expand and cool within the mold in order to form a produced object, where the produced object has a predefined shape based on the mold.

2. A method as in claim 1, where the at least one piece achieves the predefined shape due to pressure exerted by expansion of the blowing agent.

3. A method as in claim 1, where the at least one piece achieves the predefined shape only due to the pressure exerted by expansion of the blowing agent.

4. A method as in claim 1, where extruding the material through the die comprises a substantially continuous process such that the steps of cutting, placing and allowing are repeated for at least one subsequent piece in at least one additional mold.

5. A method as in claim 1, where the material comprises plastic, rubber or thermoplastic rubber.

6. A method as in claim 5, where the material comprises a polymer, a copolymer, polyethylene, polystyrene or polypropylene.

7. A method as in claim 1, where the predefined shape comprises a shape suitable for the produced object to act as a stopper for an enclosure.

8. A method as in claim 1, where the predefined shape comprises a shape suitable for the produced object to act as a synthetic wine bottle cork.

9. A method as in claim 1, wherein the produced object comprises a stopper for an enclosure.

10. A method as in claim 1, wherein the produced object comprises a synthetic wine bottle cork.

11. A system comprising:
an extruder configured to extrude a material comprising a blowing agent through a die, the extruded material comprising an extruder output; and
at least one mold configured to receive at least a portion of the extruder output, where the at least one mold defines an interior cavity of said at least one mold, said interior cavity having a specified shape, where the at least a portion of the extruder output is received in said interior cavity, where the at least a portion of the extruder output is configured to achieve the specified shape of the interior cavity by expanding and cooling within the interior cavity of the at least one mold in order to form a produced object.

12. A system as in claim 11, where the at least a portion of the extruder output achieves the specified shape due to pressure exerted by expansion of the blowing agent.

13. A system as in claim 12, where the at least a portion of the extruder output achieves the specified shape only due to the pressure exerted by expansion of the blowing agent.

14. A system as in claim 11, where the at least one mold comprises a plurality of molds, where the at least a portion of the extruder output comprises a plurality of portions, where extrusion of the material through the die by the extruder comprises a substantially continuous process such that the plurality of portions are received in a plurality of interior cavities of the plurality of molds.

15. A system as in claim 11, where the material comprises plastic, rubber or thermoplastic rubber.

16. A system as in claim 15, where the material comprises a polymer, a copolymer, polyethylene, polystyrene or polypropylene.

17. A system as in claim 11, where the specified shape comprises a shape suitable for the produced object to act as a stopper for an enclosure.

18. A system as in claim 11, where the specified shape comprises a shape suitable for the produced object to act as a synthetic wine bottle cork.

19. A system as in claim 11, wherein the produced object comprises a stopper for an enclosure.

20. A system as in claim 11, wherein the produced object comprises a synthetic wine bottle cork.
